(19) United States
(12) Patent Application Publication
(10) Pub. No.: US 2015/0016120 A1
(43) Pub. Date: Jan. 15, 2015

(54) Structure of Lighting Instrument

(71) Applicant: IOVISION Technology Co., Ltd., Taipei (TW)

(72) Inventors: Chung-I Chen, Changhua (TW); Feng-Jui Shen, Changhua (TW)

(21) Appl. No.: 13/941,566

(22) Filed: Jul. 15, 2013

(51) Int. Cl. F21V 1/02

(52) U.S. Cl. CPC F21V 1/02
USPC 362/355

(57) ABSTRACT

A lighting instrument consists of a frame that is formed by several moldings and connections, with a first scarf and second scarf placed around the upper fringe and the lower fringe of the frame, with a lagging plate and a light diffusion plate placed in the first scarf and second scarf respectively, forming a chamber along with the frame. The lagging plate is formed by more than one lagging plate unit placed lateral, with protrudes and concaves set on the left and right sides of the lagging plate units, and they can connect with other lagging plate units to meet the size of customer requirement. Also, each lagging plate unit has a circuit board with a lighting element installed on the surface facing the chamber.

### FIELD OF THE INVENTION

The present invention relates to a structure of lighting instrument, especially to the structure which is a frame structure whose frame is formed by connecting joints connected with moldings.

### BACKGROUND OF THE INVENTION

A traditional lighting instrument's structure consists of a frame on which its two sides are installed with a lagging plate and a light diffusion plate that are surrounded by the frame, with a lighting element installed on the lagging plate, forming a lighting instrument that provides light illumination.

However, the lagging plate has to accommodate with the size of the frame of traditionally lighting instrument, which results in various sizes of lagging plates being produced when making various sizes of lighting instruments, resulting in high production costs as well as high storage costs.

Thus, to resolve the previously stated problem becomes the main issue for the present invention, which was created after continuing thoughts and tests by the inventor.

### SUMMARY OF THE INVENTION

The purpose of the present invention is to provide a lighting instrument with frames assembled by connecting joints with moldings, with which to accommodate different sized frames by only cutting off moldings according into specific length, thus, the specification of the connecting joints for different sizes of lighting instrument becomes the same, therefore, effectively reducing production costs.

To achieve the aforementioned purpose, the present invention provides a lighting instrument, consisting of a frame, a lagging plate, and a light diffusion plate.

Wherein the frame is assembled by several connection joints connected with several moldings, with each molding including an inner-surface and an outer-surface. The upper-fringe of the inner surface has a first scarf for embedding the lagging plate, and the inner surface's lower-fringe has a second scarf for embedding the light diffusion plate. There is also a location notch on the outer-surface, with the lagging plate and light diffusion plate separately embedded into the first scarf and second scarf respectively. A chamber is formed by said lagging plate and light diffusion plate, and the surrounding frame. Each connection joint is comprised of two connecting parts to connect two moldings together. These two connecting parts extend toward different directions forming an included angle, and each connecting joint connects to the moldings through its connecting parts, fixing the connecting parts on the molding's location notch through a fixed structure, forming said frame.

The lagging plate is formed by more than one lagging plate unit placed laterally, with protrudes and concaves set on the left and right sides of the lagging plate units to assist the connecting of the adjacent lagging plate units. One face of each said lagging plate unit facing toward the chamber has multiple circuit boards with several lighting units on each circuit board, and each circuit board is fixed on the concaved side of each lagging notch on each lagging plate unit.

The above description of the present invention, along with its purposes and advantages, are not difficult to understand through the detailed descriptions and drawings presented below.

### BRIEF DESCRIPTION OF THE DRAWINGS

FIG. 1 is a partial disassembled scheme of present invention.

FIG. 2 is an exploded view of present invention.

FIG. 3 is an enlarged scheme of the connecting joint with 2 jointed moldings.

FIG. 4 is a vertical cross-section view of a fixed connecting joint.

FIG. 5 is a partial dissembled scheme of the lagging plate in present invention.

### DETAILED DESCRIPTION OF PREFERRED EMBODIMENT

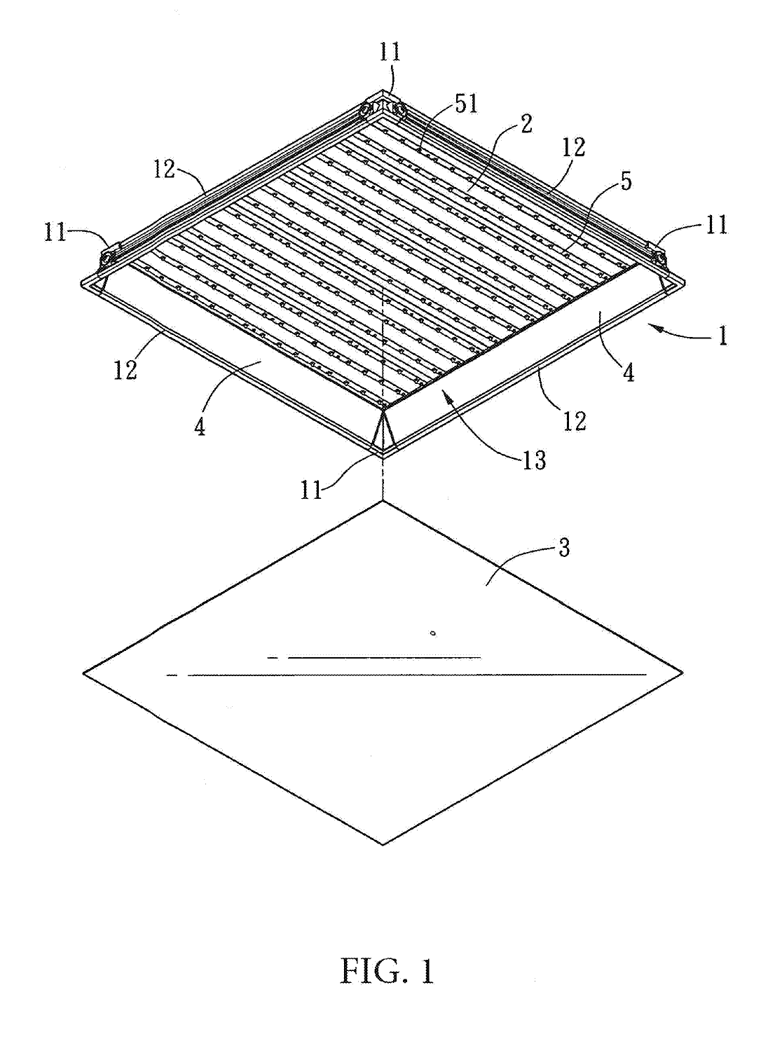

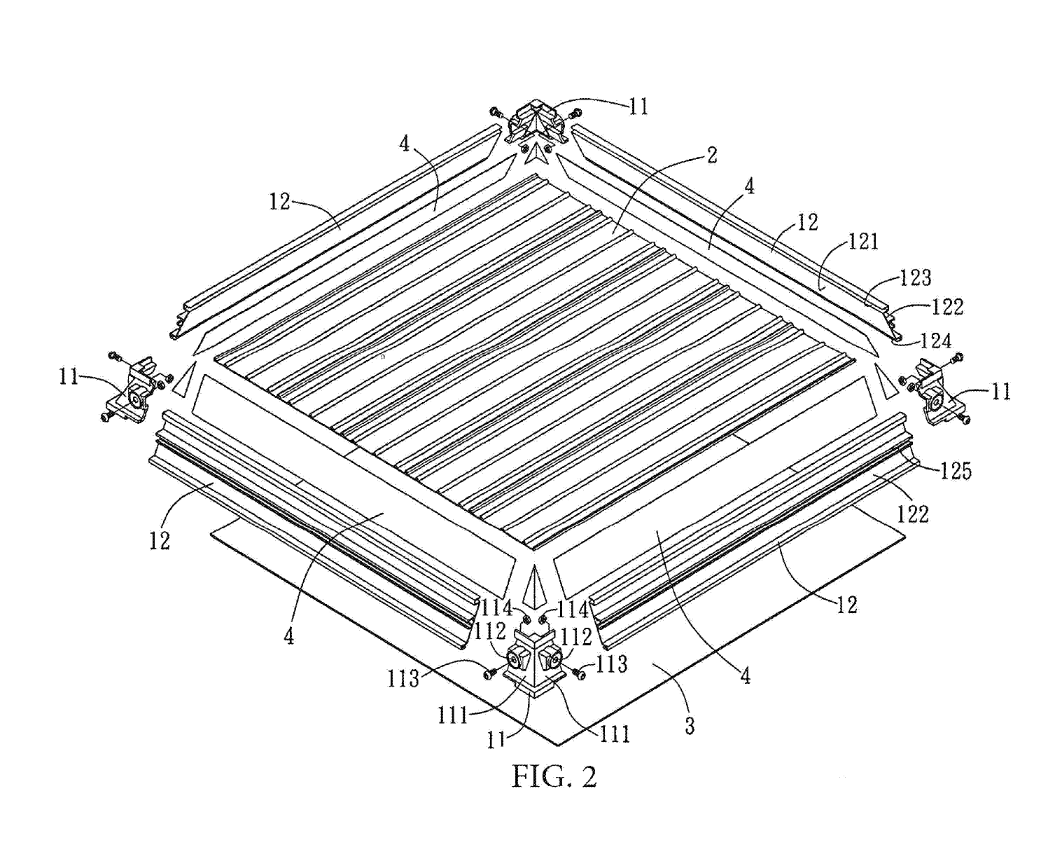

Please refer to FIGS. 1 and 2 as they show the structure of the present invention, which is formed by a frame (1), a lagging plate (2), and a light diffusion plate (3). A frame is formed by connecting four moldings with four connecting joints. Each molding (12) includes an inner-surface (121) and an outer-surface (122). The upper-fringe on the inner surface (121) has a first scarf (123) for embedding the lagging plate, and the inner surface's (121) lower-fringe has a second scarf (124) for embedding the light diffusion plate. After the first scarf (123) and second scarf (124) of each molding (12) are assembled into a frame (1). A chamber is formed by said lagging plate and light diffusion plate, and the surrounding frame (1) which is assembled by said moldings (12) and connection joints (11). On the outer-surface (122) of the molding (12) is a location notch (125) that connects the connecting joints (11). As shown in the FIG. 2, the location notch (125) is a long notch that extends according to the direction of the molding (12).

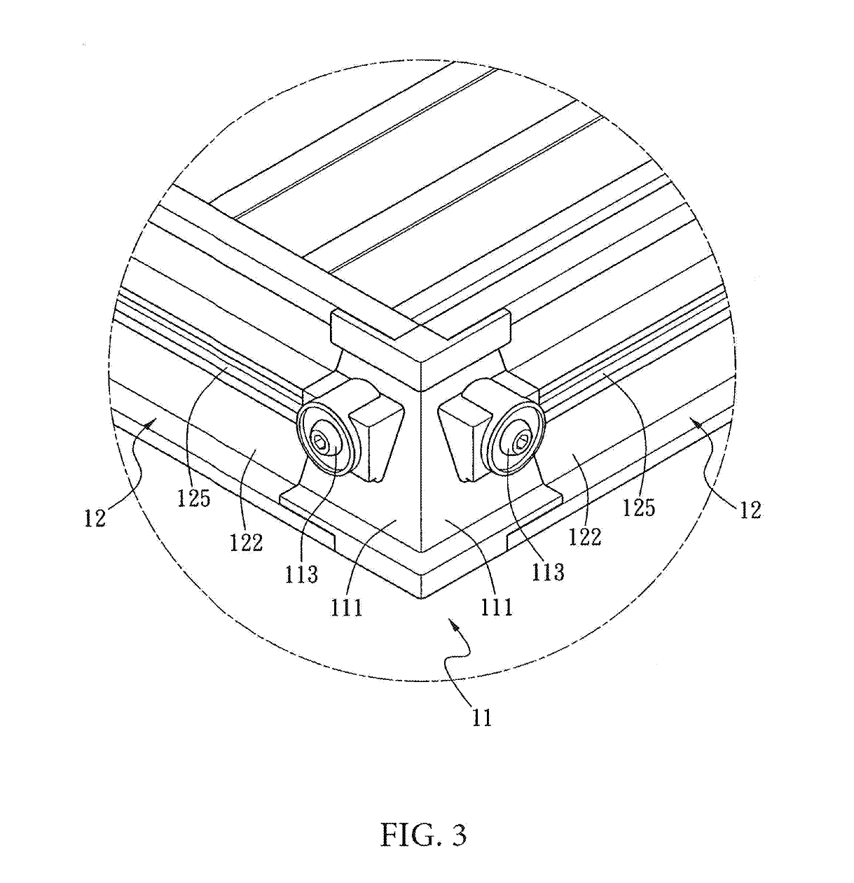

As the above description and what is shown in FIG. 3, each of the connecting joint (11) that is used to connect 2 moldings (12) has two connecting parts (111) that can connect adjacent moldings (12) together. These two connecting parts (111) extend to different directions, forming an included angle, but as a right angle in this practice.

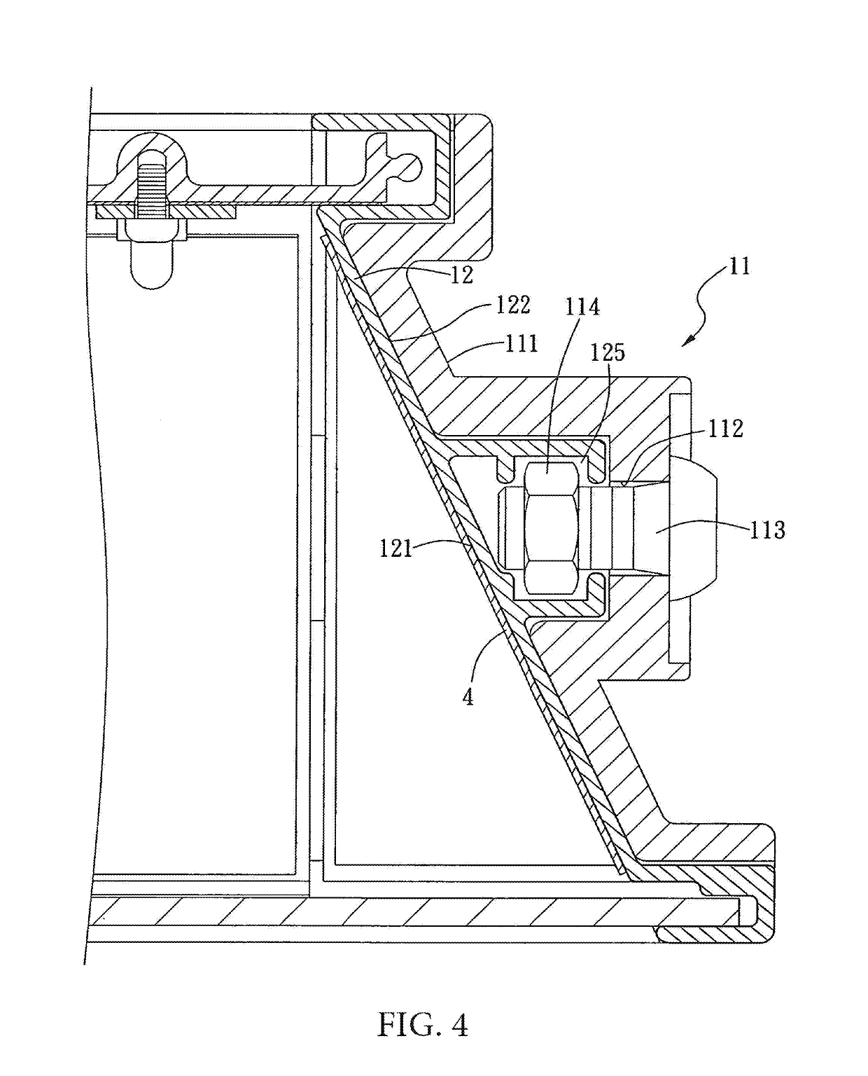

Each of connecting joint (11) connects to the molding's (12) outer-surface (122) through its connecting part (111) and fixes the connecting part (111) to the molding's (12) location notch (125) through a fixed structure, forming a frame. To be more specific, as shown in FIG. 4, a screw hole (112) is drilled through each connecting part's (111) corresponding spot with the molding's (12) location notch (125), with one screw (113) inserted through the screw hole (112) and a screw cap (114) to lock on the screw (113). The screw cap (114) is locked on said screw (113) from inside of location notch (125) of the molding (12), rotating said screw (113) to tight the connection joint (11) to the outer-surface (122) of said molding (12), to position two adjacent frames.

Besides, in the embodiment, each molding (12) is leaned at an angle with the lagging plate (2), while the connection joints (11) also have a corresponding included angle to connect said moldings (12), thus assembling a frame by said connection joints (11) and moldings (12) which has a diameter increasing from the top to bottom of the lighting instrument. A reflection film (4) is posted and covered on the inner-surface (121) of each molding (12) and corresponding inner-surface of each connection joint (11). Said reflection film (4) is made of a substance, which is white

Polyethylene Terephthalate (PET) with outstanding reflectivity and diffusivity, thus increasing the luminance by reflecting the light emitted from the light bulb.

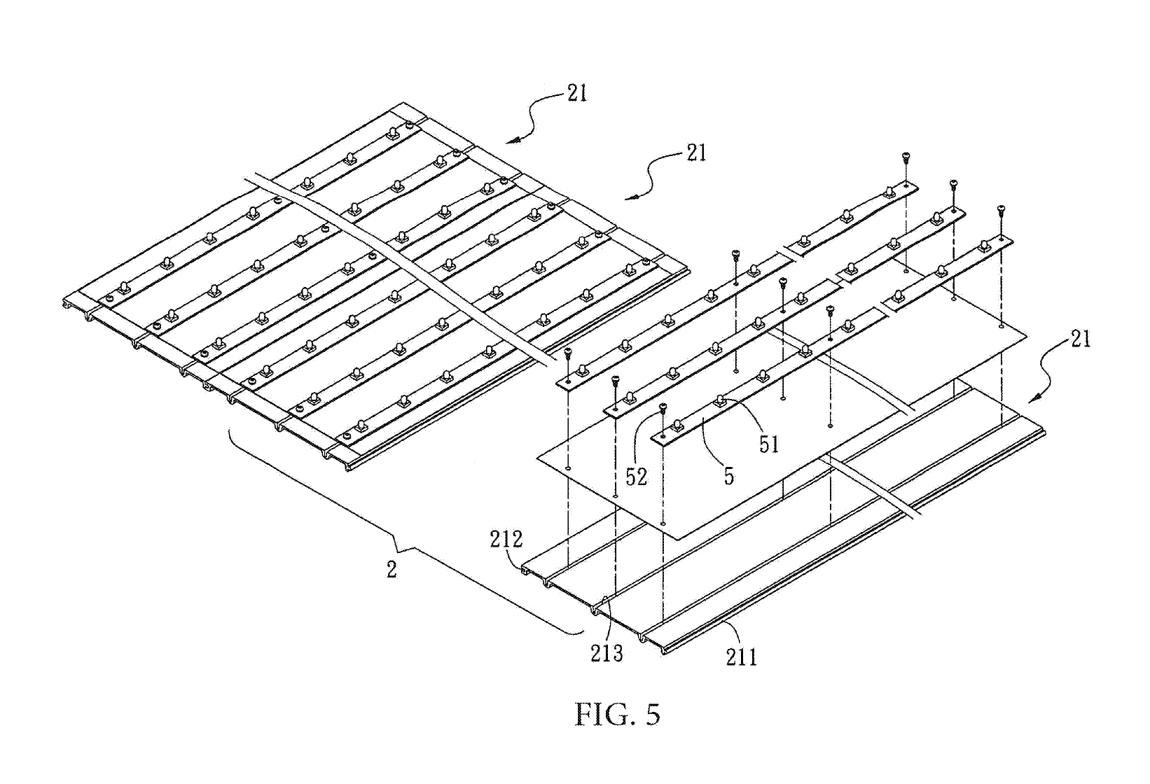

Next, by referring to FIG. 5, the lagging plate (2) of the present invention is formed by more than one lagging plate unit (21) placed lateral, with a protrude (211) and a concave (212) set on the left and right side of each lagging plate unit (21) to assist the corresponding connecting to each adjacent lagging plate unit (21). The surface of each said lagging plate unit (21) facing said chamber comprises of several location notches (213), each extending separately towards the two ends of said lagging plate unit (21). There is also a circuit board (5) with a lighting element (51) installed on corresponding position of each location notch (213), each of said circuit board (5) is fixed on said location notch (213) by several screws (52).

Concluding all that is described above, the purpose of the designation of present invention is to form a frame (1) of the lighting instrument by assembling the moldings (12) through the connecting joints (11). By this method, making lighting instruments of different sizes can be achieved by only cutting out moldings (12) into the appropriate length and assembling them to form the desired size of the frame (1) with unified connection joints (11). On the other hand, the lagging plate (2) can also be modularized through the application of lagging plate units (21), with various sizes of said lagging plates (2) made by assembling different numbers of said lagging plate units (21) to accommodate various needs. Therefore, only the units with single scale need to be manufactured to form different sizes of products for different demands, thus reducing production costs and simplifying the assembling procedures.

All practices described above are only for better embodiment of the present invention, but are not the limitation of the present invention, meaning that any modification or variations by the scope of the present invention may be feathered by what is claimed hereafter.

What is claimed is:

1. A structure of lighting instrument, is characterized in that:
A lighting instrument, comprising:
A frame;
A lagging plate, and A light diffusion plate;
Wherein said frame is assembled by several connection joints connected with several moldings, with each molding including an inner-surface and an outer-surface, the upper-fringe of the inner surface has a First Scarf for embedding the Lagging Plate, and the inner surface's lower-fringe has a Second Scarf for embedding the Light Diffusion Plate. There is also a Location Notch on the outer-surface, the Lagging Plate and Light Diffusion Plate are separately embedded into the First Scarf and Second Scarf respectively;
A chamber is formed by said lagging plate and light diffusion plate, and the surrounding frame, each connection joint is comprising two connecting parts to connect two moldings together, these two connecting parts extend toward different directions forming an included angle, and each connecting joint connects to the moldings through its connecting parts, fixing the connecting parts on the molding's location notch through a fixed structure, forming said frame;
Wherein said lagging plate is formed by more than one lagging plate unit placed laterally, with protrudes and concaves set on the left and right sides of the lagging plate units to assist the connecting of the adjacent lagging plate units, one face of said lagging plate units which are toward the chamber have multiple circuit boards with several lighting units on each circuit board, and each circuit board is fixed on the concaved side of each lagging notch on each lagging plate unit.

2. A structure of lighting instrument according to claim 1, wherein each of said molding is leaned at an angle with said lagging plate, while the connection joints also have a corresponding included angle to connect said moldings, and said frame which is assembled by said connection joints and moldings, has a diameter increasing from the top to the bottom of the lighting instrument.

3. A structure of lighting instrument according to claim 1, wherein the inner-surface of each molding and corresponding inner-surface of each connection joint are covered by the reflection film.

4. A structure of lighting instrument according to claim 3, wherein said reflection film is made of Polyethylene Terephthalate (PET) with outstanding reflectivity and diffusivity.
